(19) United States
(12) Patent Application Publication
(10) Pub. No.: US 2024/0430528 A1
(43) Pub. Date: Dec. 26, 2024

(54) APPARATUS, SYSTEMS AND METHODS FOR PERSONALISED CONTENT

(71) Applicant: Sony Interactive Entertainment Inc., Tokyo (JP)

(72) Inventors: Alan Murphy, London (GB); Richard Downey, London (GB); Oliver Hume, London (GB)

(73) Assignee: Sony Interactive Entertainment Inc., Tokyo (JP)

(21) Appl. No.: 18/741,938

(22) Filed: Jun. 13, 2024

(30) Foreign Application Priority Data
Jun. 22, 2023 (GB) 2309420.4

(51) Int. Cl. H04N 21/466; H04N 21/8549

(52) U.S. Cl. CPC H04N 21/4662; H04N 21/8549

(57) ABSTRACT

A data processing apparatus includes receiving circuitry to receive user data indicative of a plurality of content items accessed by a user within a set time interval, access circuitry to obtain a plurality of sub-items associated with one or more of the plurality of content items from one or more content sources in dependence on the user data, the plurality of sub-items each comprising at least one of image content, audio content, and text content, summary circuitry to receive a set of sub-items comprising at least some of the plurality of sub-items and generate a summary content in dependence on the set of sub-items, the summary circuitry comprising one or more machine learning models trained to generate the summary content, and storage circuitry to store the summary content.

### FIELD OF THE DISCLOSURE

The present disclosure relates to the field of processing data. In particular, the present disclosure relates to apparatus, systems and methods for generating personalised content.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Various user devices are available for enabling users to access content from a range of possible content sources. Content may be installed on one or more user devices and thus accessed without requiring use of a network connection, downloaded and/or streamed from one or more remote servers. Movies, television programmes, video games, online videos, podcasts, audiobooks, music tracks (or music playlists comprising a set of music tracks) represent examples of such content that may be accessed so that video images and/or associated audio are provided to a user via one or more user devices.

The amount of content accessible to users is becoming ever more varied and feature rich. A consequence of this is that users may be unaware of potential content that is available for being accessed. In some cases, restraints on time available to a user may be such that it may not always be feasible for users to fully explore certain content items. Further to this, even whilst enjoying a certain content item, parts of the content may go essentially unused by the user such as due to the user unintentionally missing a part of the content and/or a user making a decision to deliberately miss out (e.g. skip ahead) a part of the content for various reasons, such as limitations on their available free time.

It is in this context that the present disclosure arises.

### SUMMARY

Various aspects and features of the present invention are defined in the appended claims and within the text of the accompanying description.

### BRIEF DESCRIPTION OF THE DRAWINGS

The present technique will be described further, by way of example only, with reference to embodiments thereof as illustrated in the accompanying drawings, in which:

FIG. 1 is a schematic diagram illustrating an example of an entertainment device;

FIG. 2 is a schematic diagram illustrating a data processing apparatus;

FIG. 3 is a schematic flowchart illustrating use of feedback data;

FIG. 4 is a schematic diagram illustrating an example of a set of sub-items for which summary content is generated;

FIG. 5 is a schematic diagram illustrating an example of three sets of sub-items for different time intervals; and

FIG. 6 is a schematic flowchart illustrating a method.

### DETAILED DESCRIPTION

Embodiments of the invention will now be described, by way of example only, with reference to the accompanying drawings, in which:

FIG. 1 schematically illustrates an example entertainment device such as the Sony® PlayStation 5® (PS5) entertainment device.

The entertainment device 10 comprises a central processor (CPU) 20. This may be a single or multi core processor, for example comprising eight cores as in the PS5. The entertainment device also comprises a graphical processing unit (GPU) 30. The GPU can be physically separate to the CPU, or integrated with the CPU as a system on a chip (SoC) as in the PS5.

The entertainment device also comprises RAM 40, and may either have separate a random access memory (RAM) for each of the CPU and GPU, or shared RAM as shown in FIG. 1. Both the CPU and the GPU thus have access to RAM. The or each RAM can be physically separate, or integrated as part of an SoC as in the PS5. Further storage is provided by a disk 50, either as an external or internal hard drive, or as an external solid state drive, or an internal solid state drive as in the PS5.

The entertainment device may transmit and/or receive data via one or more data ports 60, such as a universal serial bus (USB) port, Ethernet® port, Wi-Fi® port, Bluetooth® port, Wi-Fi® port or similar, as appropriate. It may also optionally receive data via an optical drive 70.

Audio/visual outputs from the entertainment device are typically provided through one or more A/V ports 90, such as an HDMI port, or through one or more of the wired or wireless data ports 60.

An example of a device for displaying images output by the entertainment system is a head mounted display ‘HMD’ 120, such as the PlayStation VR 2 ‘PSVR2’, worn by a user 1.

Where components are not integrated, they may be connected as appropriate either by a dedicated data link or via a bus 100.

Interaction with the entertainment device is typically provided using one or more handheld controllers (130, 130A), such as the DualSense® controller (130) in the case of the PS5, and/or one or more VR controllers (130A-L, 130A-R) in the case of the HMD.

FIG. 1 therefore provides an example of an entertainment device suitable for performing processing for executing interactive content and generating video images and audio for output to a user. The entertainment device may be used for playing video games which may be executed locally by the entertainment device and/or executed by one or more remote servers. The entertainment device may for example generate images and audio for output by one or more devices such as a television and/or the head mounted display unit 120. In addition to video games, other content such as audiobooks, podcasts, online videos (e.g. associated with applications such as YouTube®, Twitch®, TikTok® and so on), movies, television programmes, music tracks, music playlists and so on may be accessed using such an entertainment device.

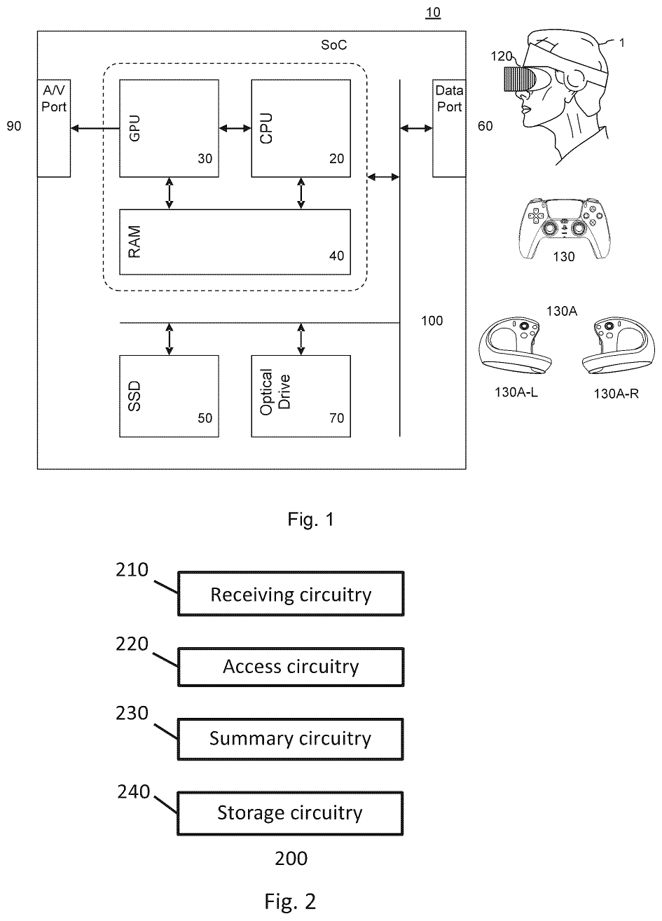

FIG. 2 schematically illustrates a data processing apparatus 200 in accordance with embodiments of the disclosure. The data processing apparatus 200 comprises receiving circuitry 210, access circuitry 220, summary circuitry 230 and storage circuitry 240.

The data processing apparatus 200 may in some cases be provided as part of an entertainment device such as that described with respect to FIG. 1. Alternatively, the data processing apparatus 200 may be provided as part of a server. For example, the data processing apparatus 200 may be provided as part of one or more servers associated with one or more of a social networking service, streaming service and/or gaming platform.

Using one or more user devices, a user may access a number of content items for a variety of purposes, such as watching a movie and/or online video and/or TV programme, playing a video game, listening to music and/or podcasts and/or audiobooks. The receiving circuitry 210 is configured to receive user data indicative of a plurality of content items that have been accessed by a user within a set time interval. The plurality of content items may comprise one or more audio-visual content items comprising both video data and audio data. Examples of such audio-visual content items may include video games, online videos, movies, TV series and video podcasts. For example, using a user device such as a video game console, the user may play a video game within the set time interval and at a later time, still within the set time interval, view one or more online videos and/or video podcasts. Alternatively or in addition, the plurality of content items may comprise one or more audio-only content items. Examples of such audio-only content items may include music tracks, music playlists, audio-only podcasts and audiobooks. For example, using a user device such as a video game console, the user may access one or more software applications to listen to an audiobook and/or an audio-only podcast.

Hence more generally, one or more user devices of the user may access a number of content items within the set time interval and user data indicative of the content items can be received by the receiving circuitry 210. For example, one or more user devices such as a smartphone and/or a video game console may be used by the user and may include functionality for monitoring a user's activities and storing user data for indicating content items that have been accessed, and optionally further associated information. Many user devices comprise programs (e.g. operating system software or other software applications) that can monitor various parameters for a user's usage, which may also indicate content items that have been accessed using the device and optionally more detailed information such as an amount of time for which a content item has been accessed.

In examples where the data processing apparatus 200 is provided as part of a server, user data from one or more of the user's devices can be communicated to the data processing apparatus 200 via one or more networks. For example, one or more user devices associated with the user may each periodically communicate user data generated by that user device to the data processing apparatus 200. In particular, upon expiry of the set time interval, the data processing apparatus 200 may be configured to receive the user data indicative of content items accessed by the user within the set time interval from one or more user devices associated with the user.

In some embodiments of the disclosure, the data processing apparatus 200 may be provided as part of a user device used for accessing content items, such as a video game console, laptop computing device or smartphone device. In particular, in some embodiments of the disclosure the data processing apparatus 200 may be provided as part of a user device that is a video game console. Hence, the data processing apparatus 200 may in some cases be a video game console (or more generally a user device) operable to generate user data indicative of a plurality of content items accessed by a user within a set time interval, and comprising the circuitry as shown in FIG. 2. The video game console may generate the user data and upon expiry of the set time interval, input the user data generated for the set time interval to the receiving circuitry 210 for processing according to the techniques discussed herein.

As discussed in more detail below, the access circuitry 220 obtains sub-items from one or more content sources in dependence on the user data. In some cases, one or more of the content sources may correspond to one or more user devices. Hence, in some examples the data processing apparatus 200 may be a video game console and one or more of the content sources from which one or more sub-items are obtained may be a storage (e.g. a solid state drive, such as that used in the PlayStation® 5) associated with the video game console.

The set time interval may be set to any appropriate value, and in some cases may be set to a default value or set according to a value that is specified by the user. In some examples, the set time interval may specify a start time and an end time such that the set time interval has a duration in the range 1-100 days, or more particularly in the range 1-10 days. For example, the set time interval may be set to start and end at a same time on a given weekday (e.g. 9:00 AM on a Friday) so that the user data is indicative of content items that have been accessed by the user within that week. In some examples, the set time interval may be set to have a duration of 7 days.

As explained above, in some examples the receiving circuitry 210 may receive the user data upon expiry of the set time interval. Using the above example of 9:00 AM on a Friday, the receiving circuitry 210 may receive user data from the user device(s) at 9:00 AM each Friday (or substantially at that time, or a soon as practicable in the case of lack of connectivity), such that the received user data is indicative of content items that have been accessed by the user within the preceding time interval (e.g. 7 days). The received user data can be used according to the techniques to be discussed below to obtain sub-items associated with one or more of the content items that have been accessed by the user within the set time interval, which may be a preprogramed value or a user-selected value, and form a set of sub-items representing a content created personally for the user which is relevant to their activities within the set time interval.

Whilst the above discussion refers to the data processing apparatus receiving the user data from each of the one or more user devices upon expiry of the set time interval, in other cases the data processing apparatus may receive the user data at any suitable time and obtain sub-items from content sources by using user data that has been received up to a the time of expiry of the set time interval. For example, upon ending a game session for a video game, user data indicating that the video game has been accessed by the user (and optionally other properties associated with the access to the video game) may be provided to the data processing apparatus 200. More generally, using timing information (e.g. timestamps) associated with the user data, user data corresponding to the set time interval can be identified and used according to the techniques to be discussed below to obtain sub-items associated with one or more of the content items that have been accessed by the user within the set time interval.

The access circuitry 220 is configured to obtain a plurality of sub-items associated with one or more of the plurality of content items that have been accessed by the user within the set time interval. The plurality of sub-items are obtained from one or more content sources in dependence on the user data. One or more of the content sources may correspond to one or more of a user device and a server. For example, in the case of the user accessing a content item such as a streamed audiobook (and/or streamed podcast), one or more sub-items for the audiobook (and/or podcast) may be obtained from a server (e.g. streaming server) associated with a streaming platform used for streaming the audiobook. Similarly, in the case of the user accessing an online video (e.g. a YouTube® video), one or more sub-items for the online video may be obtained from a server associated with a streaming platform for streaming the online video. Alternatively or in addition, in some cases the user may have accessed content such as a video game, movie, TV series, podcast, audiobook that was downloaded (at least partially or fully) to a user device, and one or more sub-items for one or more such content items may be obtained from one or more of the user devices. The access circuitry 220 thus obtains a plurality of sub-items which are identified, on the basis of the user data, as being relevant to the user's activities within the set time interval.

Hence more generally, the access circuitry 220 is configured to obtain a plurality of sub-items associated with one or more of the plurality of content items that have been accessed by the user within the set time interval by obtaining sub-items from one or more content sources in dependence on the user data, in which one or more of the content sources comprise one or more of: one or more of the user devices associated with the user; and one or more servers associated with one or more streaming services.

Content items can generally be considered as comprising a number of sub-items, such that each sub-item represents a portion of the content item. For example, an audiobook may be considered as being formed of sub-items corresponding to, for example, chapters. Similarly, in the case of a music playlist, a respective music track may correspond to a sub-item of the music playlist, and/or a segment of a music track may be considered as being a sub-item. In the case of a respective online video, a sub item may correspond to segment for the online video. In particular, in some cases online videos may be segmented into chapters (e.g. such as automatic segmentation used in some YouTube® videos). Similarly, in the case of a respective podcast, a sub-item may correspond to a chapter or other similar segment for the podcast. In the case of a video game comprising a computer generated environment (e.g. a virtual game world), a sub-item may include one or more pieces of content associated a respective object within the video game such as a game character.

A sub-item may include content, such as image content, audio content and/or text content, associated with a respective object within a video game. Alternatively or in addition, a sub-item may include image content, audio content and/or text content associated with a temporal portion within a video game, such as a scene or a level within the video game, or a cut-scene. Alternatively or in addition, a sub-item may include content associated with a spatial portion within a computer generated environment. For example, a sub-item may comprises image content, audio content and/or text content for one or more objects in a spatial portion. Such techniques are discussed in more detail later.

More generally, the access circuitry 220 obtains a plurality of sub-items for at least some of the content items that have been accessed within the set time interval, in which a respective sub-item includes content associated with a portion of a content item. The plurality of sub-items each comprise at least one of image content, audio content, and text content associated with a portion of a content item. Hence, at least some or all of the sub-items obtained by the access circuitry 220 can be used by the summary circuitry 230 for creating a personalised summary content for the user which provides a summary that is relevant to at least some of the user's previous activities within the set time interval.

The summary circuitry 230 is configured generate the summary content for the user in dependence on a set of sub-items comprising at least some of the plurality of sub-items obtained by the access circuitry 220. The summary circuitry 230 comprises one or more machine learning models trained to receive a set of sub-items comprising at least some of the plurality of sub-items and generate a summary content in dependence on the set of sub-items. The storage circuitry 240 is configured to store the summary content generated by the summary circuitry 230.

The content associated with the set of sub-items is provided as an input to one or more machine learning models. In response to the input, summary content for summarising the content associated with the set of sub-items is provided as an output. Machine learning techniques for summarising content are generally known, and any suitable machine learning model(s) for performing content summary may be used for generating the summary content. In particular, natural language processing and speech-to-text algorithms are generally known and are not discussed here in detail. An example of a suitable trained machine learning model that may be used includes OpenAI's ChatGPT (e.g. ChatGPT-4), Facebook AI's RoBERTa and Google's BERT.

More generally, the set of sub-items may be input to one or more machine learning models trained to perform natural language processing tasks. Examples of suitable machine learning models include pre-trained natural language processing (NLP) models trained to perform tasks comprising one or more from the list consisting of: text summarisation; sentiment analysis; named entity recognition; natural language generation; and speech recognition.

In the case of the set of sub-items comprising at least text content, the text content may thus be summarised by one or more of the machine learning models. In the case of the set of sub-items comprising at least audio content, the audio content may be converted to text using one or more known speech-to-text machine learning models and the resulting text then summarised by one or more of the machine learning models. In the case of the set of sub-items comprising at least image content, one or more of the machine learning models may be used to generate captions and/or descriptive tags for the image content (e.g. using known computer vision and feature extraction models) and one or more of the machine learning models may be trained to perform natural language processing tasks to generate text data in dependence on the captions and/or descriptive tags. For example, Open AI's ChatGPT-4 machine learning model is trained to receive content comprising both images and text and provide a summary of the input content, and represents an example of a suitable machine learning model that may be used for generating the summary content in the present techniques.

The summary content can thus be generated and stored by the storage circuitry 240 and output for use by the user when requested. For example, in response to receiving a request from a user device associated with the user, the data processing apparatus 200 may output the summary content to the user device. The summary content may be stored in the form of text data. Alternatively or in addition, in some cases the summary circuitry may comprise a text-to-speech model operable to generate audio data comprising speech in dependence on the text-based output of the machine learning model(s). Hence, the storage circuitry may store the summary content as one or more of text data and audio data.

The summary content can be considered to be personalised for the user in that the set of sub-items that have been summarised relate to content items that have been accessed by the user within the set time interval. The summary content may provide summaries of video game activities for one or more video games that have been played by the user, such as recent game achievements for the video games, recently encountered portions of the video game, missed portions of the video games, skipped portions of the video games, mishaps that have occurred within the video games such as repeated attempts for a given task, future portions not yet encountered for the video games, storylines for portions of the video games, summaries of tasks involved with completing portions of the video games and so on.

In some examples, in addition to receiving the user data for the user, the receiving circuitry may also receive second user data associated with a second user that is associated with (e.g. friend status) the user. In this way, by using both the user data and the second user data, sub-items relevant to both the user's activities and the second user's activities within the set time interval can be obtained and a set of sub-items comprising one or more first sub-items associated with the user and one or more second sub-items associated with the second user can be input to the machine learning model(s) for generating the summary content. Consequently, in addition to providing summaries of video game activities for one or more video games that have been played by the user, the summary content may in some cases also provide one or more summaries of video game activities for one or more video games that have been played by the second user (e.g. a friend of the user). Therefore, by playing back the summary content using a playback device (e.g. a smartphone device), the user can listen to the summary content (optionally, if desired the summary content may be provided in a text form for reading by the user) to be informed of video game activities for one or more of their friends within the set time interval. In particular, one or more summaries regarding a friend on a same gaming platform (such as the PlayStation® network) may be included in the summary content, which may be useful for informing the user of what video games their friend has been playing and/or progress that has been made and/or other events.

In some examples, the summary content may also comprise one or more links to one or more video games associated with the summary content. For example, one or more sub-items obtained by the access circuitry 220 may have associated metadata which can be used for creation of such links. Hence, when consuming the summary content (e.g. using a smartphone device), one or more links may be accessible to the user for accessing content such as content for spectating a video game that is summarised in the summary content. For example, a link to a YouTube® video and/or a Twitch® video may be provided. Hence, companion video content for the summary content may be accessible via one or more associated links and the user may have the option of choosing to access video associated with one or more of the summaries in the summary content. Alternatively or in addition, one or more associated links may provide access to one or more advertisements to allow the user to be informed of other similar (e.g. related) video games.

### Text-Based Scripts

In some embodiments of the disclosure, the machine learning model(s) is/are trained to receive the set of sub-items and generate a text-based script in dependence on the set of sub-items. Hence, the summary content may comprises a text-based script comprising text for providing a summary of the content (image, audio and/or text) included in the set of sub-items. The text based script may thus comprise a block of text that firstly summarises content associated with a one sub-item of the set of sub-items and then summarises content associated with another sub-item of the set of sub-items and so on for each sub-item included in the set of sub-items.

For example, a sub-item included in the set of sub-items may comprise audio content relating to content intended to be consumed by a player when listening to an in-game conversation between two or more in-game characters, and in some cases natural language processing techniques may be used to summarise the audio content to generate summary text content suitable for providing a summary of the in-game conversation between two or more in-game characters. Alternatively or in addition, a sub-item may comprise audio content relating to a portion of an audiobook (or podcast) and such content may be summarised and included in the text-based script generated by the summary circuitry. Alternatively or in addition, a sub-item may comprise text content relating to text to be read in a computer generated environment for a video game and such text may be summarised and included in text-based script. Alternatively or in addition, a sub-item may comprise image content depicting a portion (e.g. scene) in a video game, and the image content may be summarised and the text included in the text-based script. Other examples of types of content that may be included in the set of sub-items are discussed in more detail later.

Hence more generally, the summary circuitry 230 may generate a text-based script comprising a first portion (e.g. first set of sentences) summarising the content associated with a first sub-item of the set of sub-items, and a second portion (e.g. second set of sentences) summarising the content associated with a second sub-item of the set of sub-items. The set of sub-items may comprise any suitable number of sub-items and more generally the text-based script may comprise any suitable number of portions for summarising a number of respective sub-items included in the set of sub-items.

In some examples, the text-based script may be generated so as to smooth a transition between the text relating to one sub-item and the text relating to another sub-item using transition wording. Alternatively or in addition, data associated with a sub-item (e.g. metadata indicating one or more titles for a content item associated with that sub-item) may be used to insert one or more introductory words prior to the text associated with that sub-item for thereby providing an introduction. For example, in the case of a sub-item relating to a podcast, a title of the podcast and/or a title of an episode may be included in the text-based script prior to the text for that sub-item. Similarly, in the case of a sub-item relating to a video game, a title of the video game and/or a title of a level of the video game may be included in the text-based script prior to the text for that sub-item.

Hence, in some embodiments of the disclosure, the storage circuitry is configured to store the summary content comprising a text-based script. Alternatively or in addition, one or more text-to-speech algorithms may be used to generate an audio file for the text-based script and one or both of the audio file and the text-based script may be stored by the storage circuitry. Hence, in some embodiments of the disclosure, the storage circuitry stores at least one of a summary audio content and a summary text content generated in dependence on the set of sub-items.

Text-Based Scripts with Target Length

In some embodiments of the disclosure, the machine learning model(s) is/are trained to generate the text-based script in dependence on a target length for the text-based script. The target length may be specified as a target number of text units (e.g. words, character or sentences). The target length may be a pre-programmed default value or may be set by the user.

The target length may be derived from a target duration (in units of time) set by the user. A target time duration X minutes (e.g. 60 minutes may be set by the user) and a calculation using the target time duration and a reference value indicative of a number of text units per unit time (e.g. number of words per unit time) can be used to calculate a value for the target length. Hence, a user may specify a target duration representing a desired duration for the summary content when played back to the user, and on this basis a target length may be calculated and used for controlling the length of the text-based script to be generated.

For example, a calculation of the target length may comprise multiplying the target time duration (in units of minutes or seconds) by a number of words per unit time (in units of minutes or seconds) to calculate a target number of words. A reference value in the range of 100-200 words per minute may be used for this calculation. In this way, the summary circuitry can be operable to generate the text-based script to include a final number of words, letters or sentences according to a target.

In some examples, the one or more machine learning models are trained to generate the text-based script in dependence on the target length for the text-based script so that the text-based script substantially matches the target length, where substantially means that the text-based script has a number of text units (e.g. words, letters or sentences) within plus or minus a predetermined number of text units of a target number (such as within 5%).

In some cases, the target length for the text-based script may be a specified as a range defined by an upper value for the number of text units and a lower value for the number of text units so that the text based script is generated in dependence on the target length to have a total number of text units falling within the range.

In some examples, the summary circuitry is configured to provide, as an input to one or more of the machine learning models, the set of sub-items and a parameter specifying the target length for the text-based script that is to be generated. In particular, one or more text-summarisation NLP algorithms may be used to generate the text-based script that is summarised according to the parameter specifying the target length.

In some examples, the summary circuitry 250 can be configured to input the set of sub-items to one or more machine learning models to thereby generate a first text-based script in dependence on the set of sub-items. The summary circuitry 230 may then input the first text-based script to a respective machine learning model that is trained specifically for performing text summarisation according to the target length to thereby generate a summarised version of the first text-based script. Hence, as a first stage, the first text-based script may be generated for providing a summary with respect to each of the sub-items included in the set, and as a second stage the first text-based script may be shortened and condensed appropriately for the target length. In particular, this can allow the first stage of summarisation to be performed with the aim being to accurately summarise each of the sub-items, and the second stage of summarisation can be performed with the aim of achieving the target length. A relatively simplified machine learning model may therefore potentially be used for the second stage.

Hence more generally, in some examples natural language processing techniques may be used so that the created summary content has a playback duration that is appropriate for a target duration set by a user. For example, a user may have a commute with a given duration and/or may typically exercise for a certain duration on a given week day, and a target time duration can be set by the user so that the summary content is generated with a suitable playback duration.

### Feedback Data

As mentioned above, in some cases a target time duration may be set to a default value or may be set based on a user input so that the user decides on the target time duration. Alternatively or in addition to this, feedback data may be used to set the target time duration and/or to apply an update to an already set target time duration. For example, a default target time duration may be initially set and feedback data may be used to modify (increase or decrease) the target time duration.

In some embodiments of the disclosure, the receiving circuitry 210 is configured to receive feedback data associated with playback by the user of one or more previously generated instances of summary content, the feedback data indicative of a duration of a played back proportion of at least one of the one or more previously generated instances of summary content, and wherein the target length is set in dependence on the feedback data. Hence, an instance of summary content generated according to the techniques discussed above may be played back by a user and a duration associated with a proportion of the instance of summary content that is played back (e.g. actually consumed by the user) can be used as feedback data to set the target time duration and/or to modify a target time duration that has been previously set.

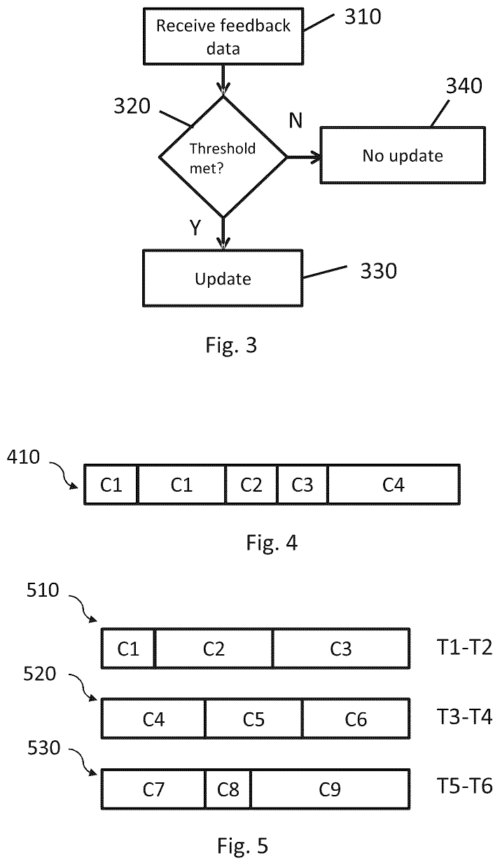

FIG. 3 is a schematic flowchart illustrating a method comprising: receiving (at step 310) feedback data indicative of a duration of a played back proportion of a previously generated summary content; determining (at step 320), based on the feedback data, whether the duration of the played back proportion of the previously generated summary content is less than a total duration of the previously generated summary content by at least a threshold time; and if so, updating (at a step 330) a value of the target time duration to a new value corresponding to a shorter target time duration. If the feedback data indicates that the duration of the played back proportion of the previously generated summary content is not smaller than the total duration of the previously generated summary content by at least the threshold time at the step 320, then the method proceeds to the step 340 so that no update is performed with respect to the target time duration.

The method of FIG. 3 can be performed using the feedback data for one or more previously generated instances of summary content to determine whether to update the target time duration. The updated target time duration can be used to set the target length to a shortened target length as discussed above so that when a next instance of summary content is to be generated (e.g. upon expiry of a set time interval), the text-based script can be generated in dependence on the shortened target length.

Hence more generally, behaviour of a user when consuming the summary content can be used as feedback to set the target length so that a next summary content to be generated can have a duration more suited to the user's behaviour, which can potentially avoid wasteful use of processing resources. Moreover, abrupt or gradual changes in lifestyle such as a different commute or different exercise routine can be accounted for by this technique.

Hence more generally, in some cases the target length for the text-based script can be set to a shorter target length in dependence on whether the feedback data indicates that a duration of a played back proportion of a previously generated summary content is smaller than a total duration of the a previously generated summary content by at least a threshold time.

The above discussion represents an example of using feedback data for a single previous instance of summary content to set the target length. However, in other examples feedback data for two or more previously generated instances of summary content may be used in a similar manner.

For example, a sliding window technique may be used with respect to feedback data for two or more most recently generated instances of summary content. The feedback data for each instance of summary content included within the window (e.g. the two most recently generated instances of summary content) may be used to calculate an average playback duration. In this way, an average (e.g. average mean) can be calculated representing an average duration that is played back by the user for two or more most recent instances of summary content, and in response to determining that the average duration that is played back is smaller than a current target time duration by at least a threshold time, then an update can be applied to the current target time duration to reduce the current target time duration. The abovementioned sliding window may have any suitable length so that feedback data for a number of most recent previous instances of summary content can be used to calculate an average playback duration, and in some examples the number of most recent previous instances of summary content Z may have a value in the range Z=2-10 instances.

The abovementioned threshold time may have a value corresponding to a given parentage of the current target time duration (e.g. N %, where N may be 5, 10, 15, 20 or 25% or any value in that range) or may instead be set to an absolute value such as Y minutes (e.g. Y may be a value in the range 2-30 minutes). The update to the target time duration may be applied using a predetermined value so as to reduce the target time duration by a predetermined amount. Alternatively, the update to the target time duration may be applied using a value that is dependent on the feedback data. For example, in the case of a using a single previous instance of summary content, the target time duration may be reduced to match (or substantially match) the duration of the played back duration for the previous instance of summary content as indicated by the feedback data. In the case of using the above mentioned sliding window technique, the target time duration may be reduced to substantially match the calculated average duration that is played back by the user for the two or more most recent previous instances of summary content.

The above discussion refers to techniques for updating the target time duration in a way that shortens a length of the text-based script that is to be generated.

In some cases, it may be that an increase in the target time duration may be desirable for the user's current circumstances. Of course, in such cases the user may provide a user input to manually specify an appropriate value for the target time duration. However, using feedback data for one or more most recent previously generated instances of summary content, the target time duration can potentially be updated to increase the target time duration without requiring this to be manually specified by the user. For example, in response to the feedback data indicating that the most recent summary content was played back in its entirety by the user, the target time duration may be incremented by a predetermined amount (e.g. add Q seconds, where Q is a predetermined value in the range 60-300 seconds) so that a next instance of summary content is generated with a longer duration. Using such a technique in combination with the above technique for shortening the target time duration, the target time duration can be dynamically varied according to the user's playback preferences so as to suit the user's needs.

Alternatively, the above mentioned sliding window technique may be used to calculate an average playback duration for two or more most recent previously generated instances of summary content (as explained above, Z may be any suitable value in the range 2-10). In response to determining that the average playback duration is either the same as or is within a second threshold time (e.g. P seconds, where P is a value in the range 1-60 seconds) of the current target time duration, then the current target time duration can be increased by a predetermined amount (e.g. add Q seconds, where Q is a predetermined value in the range 60-300 seconds). Hence more generally, in response to calculating that the user, on average, listens to an entirety or almost an entirety of the played back summary content, then the target time duration can be incremented so that next text-based script is generated using an increased target length.

### Examples of Sub-Item Sets

FIG. 4 is a schematic diagram illustrating a non-limiting example of a set of sub-items 410 that may be used for generating the summary content. In this example, the set consists of five respective sub-items ordered from left to the right and associated with four respective content items shown as C1, C2, C3 and C4. In other examples, a greater or smaller number of sub-items may be included in the set 410, and a greater or smaller number of respective content items may be represented. In the example shown, at least some of the sub-items have different data sizes which is schematically shown by the sub-items having different areas in FIG. 4.

In the example shown, two of the sub-items in the set are associated with a same content item C1. More generally, the set of sub-items used for generating the summary content may comprise one or more first sub-items each associated with a same content item (e.g. a first video game or a first podcast). However as discussed with respect to FIG. 5, in some cases each sub-item in the set may be associated with a different content item.

In the example of FIG. 4, the sub-items are ordered from left to right. The ordering of the sub-items in the set 410 may be used to determine an ordering for the summaries in the summary content. In particular, ordering of the sub-items in the set 410 may be the same as the ordering of the respective sub-item summaries provided in the summary content. For example, the set of sub-items 410 may be input to one or more of the machine learning models by inputting each sub-item according to the ordering in the set. In this way, a text-based summary generated for a sub-item may be appended to another text-based summary generated for a next sub-item and so on for each of the sub-items to thereby create a text-based script within which the respective sub-items of the set 410 are discussed in order.

In the example set 410 in FIG. 4, each respective sub-item may comprise any of the following: only image content; only audio content; only text content; or any combination thereof (such as image content and audio content). For example, a respective sub-item may comprise image content associated with a temporal and/or spatial portion of a video game (e.g. a sequence of image frames with accompanying audio). In some examples, a respective sub-item may comprise image content associated with a portion of a movie or TV programme. In some examples, a respective sub-item may comprise audio content associated with a spoken dialogue for an audio book, or audio content associated with a spoken dialogue between two podcast hosts, or audio content associated with a spoken dialogue between two or more video game characters, or audio content associated with a spoken dialogue for summarising a portion of a video game. In particular, in some examples, a game developer may create a sub-item for a portion of a video game for providing a summary audio description and/or summary text description for the portion of the video game, and one or more such sub-items may be obtained by the access circuitry from one or more of the content sources. Similarly, a respective sub-item may comprise text content associated with a dialogue for an audio book, or text content associated with a dialogue between two podcast hosts, or text content associated with a dialogue for summarising a portion of a video game. In some examples, a portion of a content may comprise both image content and audio content which can be included in a respective sub-item.

FIG. 5 schematically illustrates an example of three respective sets of sub-items 510, 520, 530. Each of the sets 510-530 corresponds to a different respective time interval. The set 510 comprises sub-items obtained in dependence on user data for the time period T1-T2. The set 520 comprises sub-items obtained in dependence on user data for the time period T3-T4. The set 530 comprises sub-items obtained in dependence on user data for the time period T5-T6. Hence, the set 510 can be input to one or more of the machine learning models to generate summary content for the time period T1-T2. Similarly, set 520 can be input to one or more of the machine learning models to generate summary content for the time period T3-T4, and set 530 can be input to one or more of the machine learning models to generate summary content for the time period T5-T6.

In the example shown, each set comprises three sub-items, however, a number of sub-items in each of the sets may be different. As explained above, each of the sets 510, 520, 530 includes sub-items relevant to the user data for that time interval. In this example, the content items (C1-C9) differ for each of the sets. However, in other examples one or more sub-items associated with a same content item (e.g. C1) may be included in one or more of the respective sets. Of course, whether or not this this case is dependent on the properties of the user data for the respective time intervals.

The first time interval T1-T2 may for example correspond to a first given time duration (e.g. one week) with T1 representing a start time for the interval and T2 representing an end time for the interval. In the example shown, the second time interval T3-T4 may have a same time duration (e.g. also one week) and starting either at or subsequent to the end time T2 of the first time interval. For example, T2 may be set to end at a given time and T3 may be set to start either at the same given time, or one second later or one minute later. The time interval T5-T6 may be set similarly so as to follow the second time interval T3-T4.

In the example shown in FIG. 5, each of the sets 510, 520, 530 is shown as having a same data size (by having a same total area in the schematic diagram). However, in other examples the sets may have different data sizes.

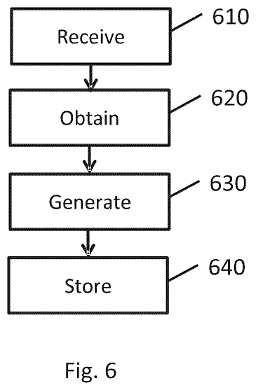

FIG. 6 is a schematic flowchart illustrating a method comprising: receiving (at a step 610) user data indicative of a plurality of content items accessed by the user within a set time interval (e.g. T1-T2); obtaining (at a step 620) a plurality of sub-items associated with one or more of the plurality of content items from one or more content sources in dependence on the user data, the plurality of sub-items each comprising at least one of image content, audio content, and text content; generating (at a step 630) a summary content in dependence on a set of sub-items (e.g. 510) comprising at least some of the plurality of sub-items, generating a summary content in dependence on a set of sub-items comprising at least some of the plurality of sub-items, in which generating the summary content comprises inputting the set of sub-items to one or more machine learning models trained to generate the summary content in dependence on the set of sub-items; and storing (at a step 640) the summary content.

The method of FIG. 6 may be performed periodically so that an instance of summary content is periodically generated. For example, the method of FIG. 6 may be performed upon expiry of the time interval T1-T2 to generate a first instance of summary content for the time interval T1-T2, and then performed upon expiry of the time interval T3-T4 to generate a second instance of summary content for the time interval T3-T4 and so on.

Hence referring again to FIG. 2, in some embodiments of the disclosure the receiving circuitry 210 is configured to receive second user data indicative of a second plurality of content items accessed by the user within another set time interval starting at or subsequent to an end of the set time interval, and wherein: the access circuitry 220 is configured to obtain a second plurality of sub-items associated with one or more of the second plurality of content items from one or more content sources in dependence on the second user data, the second plurality of sub-items each comprising at least one of image content, audio content, and text content; the summary circuitry 230 is configured to generate a second summary content in dependence on a second set of sub-items comprising at least some of the second plurality of sub-items using one or more of the machine learning models; and the storage circuitry is configured to store the second summary content.

Depending on the user data, the sub-items and the content sources may vary from one interval to the next. In particular, in some cases at least some or all of the accessed content items may be video games accessed using a video game console, and the summary content can be generated for allowing the user to catch up on one or more of missed portions of a video game, future portions of a video game accessible by continued game play of the video game and/or recaps of played portions. Potentially, the summary content may comprise one or more pieces of content corresponding to a summary of one or more in-game achievements by the user.

### Selection of Sub-Items

In some embodiments of the disclosure, the summary circuitry is configured to generate a summary content in dependence on a set of sub-items comprising a subset of the plurality of sub-items obtained by the access circuitry 220. Hence, the summary content may relate to only a selected subset of the sub-items that are obtained in dependence on the user data. In particular, selection may be performed in one or more ways that can improve the likelihood of the summary content being of interest for the user.

For example, the summary circuitry may be configured to select, from the plurality of sub-items obtained by the access circuitry 220, a subset of the plurality of sub-items. Alternatively or in addition, selection of the subset may be achieved by inputting the sub-items obtained in dependence on the user data to one or more of the machine learning models so that one or more of the machine learning models generate the summary content in dependence on a subset of the sub-items.

Hence more generally, in some embodiments of the disclosure the summary circuitry is configured to generate a summary content in dependence on a set of sub-items comprising a subset of the plurality of sub-items, in which the subset of the plurality of sub-items selected by the summary circuitry in dependence on one or more selection parameters. The one or more selection parameters may be used by the summary circuitry to control how the subset is selected and/or may be input to one or more of the machine learning models for use in selecting the subset.

In some examples, one or more of the selection parameters may specify one or more user preferences for the user, and optionally one or more priority ratings, for use in selecting the subset. User preferences such as one or more preferred genres for a content type may be specified for allowing selection from the plurality of sub-items of a subset of sub-items to be more suited to one or more of the user's preferences.

In some embodiments of the disclosure, one or more of the selection parameters specify one or more user preferences of the user comprising one or more from the list consisting of: one or more video game genres; one or more video game titles; one or more video game sets comprising a plurality of associated video game titles; one or more podcast genres; and one or more audiobook genres. In this way, types of entertainment content (e.g. video games, podcasts, audiobooks, movies, television programmes) can be specified and preferred genres for those types of entertainment content can be specified. Examples of suitable genres for movies and/or TV programmes and/or audiobooks may be action, horror, comedy and so on. For podcasts genres may include comedy, sport, news and politics, health and wellness and so on. For video games, genres may include shooter games, racing games, adventure games and so on. A video game set comprises a plurality of video games associated by one or more of: being part of a same game series (e.g. the video game series Call of Duty® which comprises a number of respective video game titles); featuring one or more common characters; featuring one or more common settings; and being released by a same developer or publisher.

One or more of the selection parameters may thus specify one or more user preferences, and therefore one or more sub-items corresponding to the user's preferences can be preferentially selected for being included in the set of sub-items that is to be summarised. For example, metadata associated with one or more sub-items may specify one or more of a title for the sub-item and/or the associated content item and/or one or more genres or other similar classifications for the associated content item. Using such metadata, preferential selection of a subset of sub-items determined to be of interest for the user can be performed to form the set of sib-items.

In some examples, the user preferences may further specify a priority rating associated with one or more of the user preferences. For example, the user may specify that shooter video games are to have a higher priority than racing games. Alternatively or in addition, the user may specify that video games generally are to have a higher priority than audiobooks. More generally, the user can specify their preferences and a relative priority rating for at least some of their preferences.

Consequently, sub-items to be included in the set can be selected in dependence on one or more of the selection parameters specifying user preferences and one or more priority ratings for at least some of the user preferences. This can improve a likelihood of the summary content being of interest to the user.

In some embodiments of the disclosure, the summary circuitry 230 is configured to define an ordered sequence for the set of sub-items in dependence on the user preferences and priority ratings associated with the user preferences, and wherein the summary circuitry is configured to generate the summary content in dependence on the ordered sequence of sub-items. In some cases, the sub-items can be arranged in an ordered sequence starting from high priority to low priority. Consequently, the resulting summary content can be generated so that it includes respective summaries for respective sub-items which are also ordered according to the ordering of the set of sub-items so that the respective summaries are also ordered starting from high priority to low priority. Referring to the example of FIG. 4, the set 410 may be used so that the first sub-item (left-most sub-item) corresponds to a user preference indicated as having a higher priority, and the second sub-item (sub-item adjacent to and to the right of the first sub-item) corresponds to a user preference indicated as having a same or lower priority, and the respective sub-items are ordered accordingly from left to right in order from high to low priority. In the case of two or more sub-items having a same priority, an ordering for those sub-items can be chosen randomly.

### Examples of Obtaining Non-Accessed Sub-Items

The above discussion refers to the access circuitry 220 obtaining a plurality of sub-items in dependence on user data indicative of content items that have been accessed by the user within the set time interval. The plurality of sub-items obtained in dependence on the user data may thus comprise one or more of: one or more sub-items previously accessed (at least partially) by the user; and one or more sub-items not previously accessed by the user. Hence, the set of sub-items which are to be summarised by the machine learning techniques may potentially include sub-items comprising content for providing the user with a recap of portions of content items that were previously accessed by the user and/or content for portions of content items that were not previously accessed by the user.

The summary content may therefore include a summary generated for one or more accessed sub-items corresponding to accessed portions of content items, such as portions of audiobooks, podcasts and video games. Alternatively or in addition, the summary content may also include a summary generated for portions of content items that have not been accessed by the user potentially because the user has missed the portion due to being unaware of the portion or chose not to access the portion (e.g. due to limited available time) can be provided.

More generally, while some sub-items of a content item may have been accessed by the user, one or more other sub-items of that same content item may not have been accessed either due to the user intentionally missing the given sub-item (i.e. being aware of the availability of the given sub-item and choosing not to access the content of the given sub-item) or unintentionally missing the given sub-item due to not being aware the availability of the given sub-item. Such a given sub-item can potentially be included in the set of sub-items. An example of this may be when a user is exploring a computer generated environment for a video game and either chooses to miss out certain content (e.g. when seeking to complete a level with only limited available time) or is unaware of certain content within the computer generated environment.

In some examples, the user data may indicate one or more previously accessed content items, and the access circuitry 220 may obtain the sub-items from one or more of the content sources by obtaining a random selection of sub-items associated with one or more of the content items. For example, in the case of a content source that is a remote content sever storing the content item and each of the constituent sub-items, the access circuitry can be configured to send an access request to the content source specifying the content item, and a random selection of sub-content items may be returned to the access circuitry. In this way, the plurality of sub-items obtained in dependence on user data may comprise one or more of: one or more sub-items previously accessed (at least partially) by the user; and one or more sub-items not previously accessed by the user.

In particular, for some video games the computer generated environments may be feature rich to the extent that, for a user with limited free time for playing a video game, it may not be feasible to fully explore the environment. For example, dialogue associated with certain virtual characters may be skipped by the user. Similarly, visual representations of text in the environment for providing information such as storyline information and/or lore (e.g. a lore book in a video game) may be skipped by the user. Hence, audio and/or text content associated with such portions can be included in the set of sub-items for allowing this to be played back to the user at a later time when the user has time available for this.

In the case of computer generated environments for video games (e.g. a virtual reality environment), a user when exploring and/or progressing through the computer generated environment may miss one or more portions for a number of reasons. A virtual object (e.g. virtual avatar, virtual phone, virtual book, virtual display screen and so on) may have associated audio and/or text which is missed by the user. In particular, dialogue for a virtual avatar and/or text content placed at positions within the environment may be missed by the user. For example, a sub-item associated with dialogue for a virtual avatar and/or another sub-item associated with text for an object (e.g. virtual book) may have not been accessed by the user. Hence, one or more sub-items obtained by the access circuitry 220 may comprise one or more of audio content, and text content associated with missed portions of a computer generated environment for a video game that has been played by the user within the set time interval.

In the above discussion, the user data is indicative of at least a plurality of content items that have been accessed by the user within the set time interval. However, as discussed below, the user data may provide a more specific (e.g. granular) indication by providing an indication of one or more respective sub-items with respect to one or more of the accessed content items.

In some embodiments of the disclosure, the user data is indicative of one or more previously accessed sub-items associated with a respective content item of the plurality of content items. Alternatively or in addition, in some embodiments of the disclosure the user data is indicative of one or more non-accessed sub-items associated with a respective content item of the plurality of content items. The access circuitry 220 can be configured to obtain one or more non-accessed sub-items associated with a respective content item of the plurality of content items in dependence on such user data. Hence, in some embodiments of the disclosure the set of sub-items (e.g. set 310) comprises one or more non-accessed sub-items associated with a respective content item of the plurality of content items, each non-accessed sub-item having not been accessed by the user within the set time interval, and each non-accessed sub-item being associated with a portion of a respective content item of the plurality of content items.

In some examples, each sub-item of the set of sub-items which is input to the machine learning model(s) may correspond to a non-accessed sub-item that has not been accessed by the user within the set time-interval. Hence in this case the set of sub-items may be used for providing the user with content relating to one or more of: missed portions of one or more accessed content items; and future portions of one or more accessed content items. Alternatively, in some examples, the set of sub-items may comprise a combination of one or more non-accessed sub-items and one or more accessed sub-items. In this way, the one or more non-accessed sub-items include content relating to missed and/or future portions and the one or more accessed sub-items may include content relating to one or more recaps.

Hence more generally, in some cases the data processing apparatus 200 generates the summary content with respect to the user's activities within the set time interval and the summary content may provide summary of “here's a recap of what you did” and/or “here's some information that you missed” and/or “here's some information for future portions”.

Respective sub-items that have been accessed by the user can be tracked and identified by the user data. For example, in the case of an audiobook, one or more sections and/or chapters that have been accessed can be indicated by the user data. Using the user data, the access circuitry can thus specifically obtain one or more non-accessed sections and/or chapters of the audiobook without obtaining one or more sections and/or chapters that have already been accessed. For example, in the case where the audiobook is stored by a remote content server (and/or a user device, if downloaded to the user device), the data processing apparatus can transmit an access request specifying one or more of the previously accessed sub-content items, and selection can be performed on the basis of the access request to select one or more non-accessed sub-content items to be returned to the data processing apparatus. In some examples, the access request may comprise metadata for a content item specifying one or more accessed sub-items and the content source may similarly store metadata in association with at least some of the sub-content items for the content item, and metadata comparison can be used to select one or more non-accessed sub-items.

Hence more generally, one or more user devices can track sub-content items that have been accessed. Tracking of accessed sub-content items may be achieved in a number of ways. For example, monitoring of metadata associated with a user's access for a content item may be used for detecting accessed sub-items. Alternatively or in addition, computer vision techniques may be used for detecting accessed sub-items. Alternatively or in addition, analysis of program code associated with an interactive content item (such as a video game) may be used to detect instances of program code associated with sub-items to thereby determine one or more accessed sub-items. More generally, one or more of the user devices can be configured to detect accessed content items and detect one or more accessed sub-items for one or more of the accessed content items and generate user data indicative of one or more previously accessed sub-items that have been accessed within the set time interval.

Therefore, using user data indicative of one or more accessed sub-items for at least one respective content item of the plurality of content items accessed by user within the set time interval, the sub-items that are obtained by the access circuitry can potentially be restricted to just non-accessed sub-items. This can allow creation of a set of sub-items that provides audio and/or text content for portions of content items that have not been accessed by the user (e.g. unintentionally missed or intentionally missed). The set of sub-items can be summarised by the machine learning model(s) and the resulting summary content can be played back to the user to provide the user with content relating to other aspects of the content item(s) that the user may have not been aware of, and which may thus incentivise further interaction by the user with the content item(s) in the future.

For example, a content source such as a remote server storing the content item may store metadata associated with at least some of the sub-items. In response to receiving, from the access circuitry, an access request comprising metadata specifying one or more accessed sub-items, metadata comparison can be used to identify one or more non-accessed sub-items (e.g. by comparing metadata of the access request with an instance of metadata for a sub-item and detecting that the instance of metadata for the sub-item does not have a match) which can be provided to the access circuitry in response to the access request. In some examples, each identified non-accessed sub-item may be provided to the data processing apparatus or a random selection of some of the non-accessed sub-items may be provided.

In some examples, sub-items for one or more content items may be considered as being grouped or linked. Metadata associated with a sub-item may uniquely identify the sub-item and also identify a grouping for the sub-item. For example, in a video game, a portion of a video game, such as given video game level or scene, may comprise a number of sub-items. Hence, when the user data indicates one or more accessed sub-items corresponding to a given grouping (e.g. a given video game level), one or more non-accessed sub-items corresponding to the given grouping can be obtained by the access circuitry. This can be particularly beneficial in that one or more non-accessed sub-items for a scene or level that has previously been accessed by the user can be obtained and used for creating the personalised content (set of sub-items) to thereby provide the user with information that they have missed when playing the video game.

Hence, in some embodiments of the disclosure, the user data is indicative of one or more previously accessed sub-items associated with a respective content item of the plurality of content items, and the access circuitry is configured to obtain one or more non-accessed sub-items associated with the respective content item of the plurality of content items in dependence on the user data, in which at least one of the previously accessed sub-items is associated with at least one of temporal portion and a spatial portion of a video game, and the access circuitry is configured to obtain one or more non-accessed sub-items also associated with at least one of the temporal portion and the spatial portion of the video game. Hence, one or more accessed sub-items may be associated with a same level, same scene and/or same temporal segment in a video game, and one or more non-accessed sub items also associated with that same level, scene and/or segment can be obtained. Alternatively or in addition, the user data may be indicative of one or more accessed sub-items associated with the temporal and/or spatial portion of the video game, and one or more non-accessed sub-items associated with a next temporal and/or spatial portion may be obtained (e.g. a next scene or level).

In a similar manner, one or more accessed sub-items may correspond to a chapter or section in an audiobook or a podcast, and a next non-accessed chapter or section can be identified accordingly an obtained. More generally, in some embodiments of the disclosure the user data may be indicative of one or more accessed sub-items associated with a temporal and/or spatial portion of a content item, and one or more non-accessed sub-items associated with a same temporal and/or spatial portion can be obtained. Alternatively or in addition, the user data may be indicative of one or more accessed sub-items associated with a temporal and/or spatial portion of a content item, and one or more non-accessed sub-items associated with a next temporal and/or spatial portion can be obtained.

Alternatively or in addition to indicating one or more accessed sub-items, the user data may be indicative of one or more non-accessed sub items for a content item that has been accessed within the set time interval. For example, detection of an input from a user during an access to a content item to skip a portion of the content item may be used for this. Detection of a fast forward request when accessing an audio-only content item such as a podcast or audiobook may be used. Detection of a skip request with respect to one or more cut scenes in a video game (so that the cut scene is a skipped portion of the video game) may be used. Alternatively or in addition, in the case of a video game, a detection of a current game level or scene provides an indication of a current progression with respect to the video game and non-accessed sub-items can thereby be identified as being content associated with one or more further levels or scenes yet to be reached.

In some embodiments of the disclosure, the access circuitry is configured to obtain one or more non-accessed sub-items associated with one or more of the plurality of content items in dependence on the user data, and one or more of the non-accessed sub-items comprise at least one of image content, audio content, and text content associated with one or more from the list consisting of: a skipped portion of a video game; a skipped in-game dialogue in a video game; a skipped virtual object in a computer generated environment associated with a video game; a future portion of a video game accessible by continued progression of the video game by the user; a skipped portion of an audio-only content (e.g. podcast, audiobook, music track, music playlist); and a future portion of an audio-only content (e.g. accessible by skipping ahead relative to a last accessed portion and/or accessible by continued listening of the audio-only content).

In some embodiments of the disclosure, in a first mode of operation the set of sub-items comprises only a plurality of non-accessed sub-items associated with one or more respective content items of the plurality of content items, and in a second mode of operation the set of sub-items comprises only a plurality previously accessed sub-items associated with one or more respective content items of the plurality of content items, wherein one of the first mode of operation and the second mode of operation is selected in response to a user input by the user. In this way, summary content that includes summaries for previously accessed portions (i.e. for providing a recap of the user's activities) can be generated for the first mode of operation. Conversely, summary content that includes summaries for non-accessed portions (e.g. for providing a summary of missed portions and future portions) can be generated for the second mode of operation so that the user can choose which of two types of summary content they desire.

### Output of Summary Content

The data processing apparatus 200 may output the summary content to any suitable user device associated with the user. In response to receiving a request from a user device of the user for summary content, the data processing apparatus can be operable to transmit the summary content to the user device.

In some embodiments of the disclosure, a system comprises the data processing apparatus 200 and a portable audio playback device, wherein the data processing apparatus is configured to transmit the summary content for output to the user by the portable audio playback device. In some examples, the portable audio playback device is one from the list consisting of: a smartphone device; smartwatch, headphones; and an HMD. In particular a portable device may be available to a user when away from home such as during a commute or during outdoor exercise. Hence, the summary content can be played back to a user to provide a summary of activities by the user within the set time interval at a time when the user is away from their home environment.

In particular, in some cases the set of sub-items may comprise one or more sub-items associated with one or more content items that are video games that have been played by the user within the set time interval. Examples of video game related sub-items may provide content such as content for recaps of previously accessed game portions, content for recaps of storylines, content for game achievements, content for mishaps and/or content for non-accessed game portions (e.g. skipped portions or future portions). Therefore, by generating the summary content in dependence on the set of sub-items, the summary content can potentially provide a plurality of summaries relevant for various video game related activities by the user, and the summary content can be played back to the user when away from their video game console, such as when commuting or exercising.

In some embodiments of the disclosure, the user data may indicate a plurality of content items that have been accessed by a first user device (e.g. a video game console or laptop) within the set time interval. The set of sub-items may be obtained according to the techniques discussed above and used to create the summary content. The summary content may then be output to a second user device (e.g. smartphone device) in response to receiving a request for the summary content from the second user device. Consequently, personalised summary content relevant to video game console related activities can be played back to a user when away from their video game console, such as when commuting or exercising.

It will be appreciated that example embodiments can be implemented by computer software operating on a general purpose computing system such as a games machine. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

Thus any required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

It will also be apparent that numerous modifications and variations of the present disclosure are possible in light of the above teachings. It is therefore to be understood that within the scope of the appended claims, the disclosure may be practised otherwise than as specifically described herein.

Example(s) of the present technology are defined by the following numbered clauses:
1. A data processing apparatus comprising: receiving circuitry to receive user data indicative of a plurality of content items accessed by a user within a set time interval; access circuitry to obtain a plurality of sub-items associated with one or more of the plurality of content items from one or more content sources in dependence on the user data, the plurality of sub-items each comprising at least one of image content, audio content, and text content; summary circuitry to receive a set of sub-items comprising at least some of the plurality of sub-items and generate a summary content in dependence on the set of sub-items, the summary circuitry comprising one or more machine learning models trained to generate the summary content; and storage circuitry to store the summary content.
2. The data processing apparatus according to clause 1, wherein one or more of the machine learning models are trained to generate a text-based script in dependence on the set of sub-items.
3. The data processing apparatus according to clause 2, wherein one or more of the machine learning models are trained to generate the text-based script in dependence on a target length for the text-based script.
4. The data processing apparatus according to clause 3, wherein the target length is set in dependence on feedback data associated with playback by the user of one or more previously generated instances of summary content, the feedback data indicative of a duration of a played back proportion of at least one of the one or more previously generated instances of summary content.
5. The data processing apparatus according to any preceding clause, wherein the set of sub-items comprises one or more non-accessed sub-items associated with a respective content item of the plurality of content items, each non-accessed sub-item having not been accessed by the user within the set time interval, and each of the one or more non-accessed sub-items associated with the respective content item being associated with a portion of the respective content item.
6. The data processing apparatus according to any preceding clause, wherein in a first mode of operation the set of sub-items comprises only a plurality of non-accessed sub-items associated with one or more respective content items of the plurality of content items, and in a second mode of operation the set of sub-items comprises only a plurality previously accessed sub-items associated with one or more respective content items of the plurality of content items, wherein one of the first mode of operation and the second mode of operation is selected in response to a user input by the user.
7. The data processing apparatus according to any preceding clause, wherein the user data is indicative of one or more previously accessed sub-items associated with a respective content item of the plurality of content items, and wherein the access circuitry is configured to obtain one or more non-accessed sub-items associated with the respective content item of the plurality of content items in dependence on the user data.
8. The data processing apparatus according to clause 7, wherein at least one of the previously accessed sub-items is associated with at least one of temporal portion and a spatial portion of a video game, and the access circuitry is configured to obtain one or more non-accessed sub-items also associated with at least one of the temporal portion and the spatial portion of the video game.
9. The data processing apparatus according to any preceding clause, wherein the user data is indicative of one or more non-accessed sub-items associated with a respective content item of the plurality of content items, and wherein the access circuitry is configured to obtain one or more of the non-accessed sub-items associated with the respective content item of the plurality of content items in dependence on the user data.
10. The data processing apparatus according to clause 9, wherein one or more of the non-accessed sub-items comprise at least one of image content, audio content, and text content associated with one or more from the list consisting of: a skipped portion of a video game; a skipped in-game dialogue in a video game; a skipped virtual object in a computer generated environment associated with a video game; a future portion of a video game accessible by continued progression of the video game by the user; a skipped portion of an audio-only content; and a future portion of an audio-only content.
11. The data processing apparatus according to any preceding clause, wherein the receiving circuitry is configured to receive second user data indicative of a second plurality of content items accessed by the user within another set time interval starting at or subsequent to an end of the set time interval, and wherein: the access circuitry is configured to obtain a second plurality of sub-items associated with one or more of the second plurality of content items from one or more content sources in dependence on the second user data, the second plurality of sub-items each comprising at least one of image content, audio content, and text content; the summary circuitry is configured to generate a second summary content in dependence on a second set of sub-items comprising at least some of the second plurality of sub-items using one or more of the machine learning models; and the storage circuitry is configured to store the second summary content.
12. The data processing apparatus according to any preceding clause, wherein the set of sub-items comprises a subset of the plurality of sub-items selected in dependence on one or more selection parameters that specify one or more user preferences.
13. The data processing apparatus according to clause 12, wherein the one or more user preferences comprise one or more from the list consisting of: one or more video game genres; one or more video game titles; one or more video game sets comprising a plurality of associated video game titles; one or more podcast genres; and one or more audiobook genres.
14. The data processing apparatus according to clause 12 or clause 13, wherein the summary circuitry is configured to define an ordered sequence for the set of sub-items in dependence on the user preferences and priority ratings associated with the user preferences, and wherein the summary circuitry is configured to generate the summary content in dependence on the ordered sequence for the set of sub-items.
15. The data processing apparatus according to any preceding clause, wherein the user data is indicative of a plurality of content items accessed using one or more user devices of the user within the set time interval, the one or more user devices comprising one or more of a video game console and a smartphone device.
16. The data processing apparatus according to any preceding clause, wherein the plurality of content items comprise at least one of one or more audio-visual content items and one or more audio-only content items.
17. The data processing apparatus according to any preceding clause, wherein the plurality of content items comprise one or more video games.
18. A computer implemented method comprising: receiving user data indicative of a plurality of content items accessed by a user within a set time interval; obtaining a plurality of sub-items associated with one or more of the plurality of content items from one or more content sources in dependence on the user data, the plurality of sub-items each comprising at least one of image content, audio content, and text content; receiving, by summary circuitry, a set of sub-items comprising at least some of the plurality of sub-items and generating summary content in dependence on the set of sub-items, the summary circuitry comprising one or more machine learning models trained to generate the summary content; and storing the summary content.
19. Computer software which when executed by a computer causes the computer to perform the method according to clause 18.

1. A data processing apparatus comprising:
receiving circuitry to receive user data indicative of a plurality of content items accessed by a user within a set time interval;
access circuitry to obtain a plurality of sub-items associated with one or more of the plurality of content items from one or more content sources in dependence on the user data, the plurality of sub-items each comprising at least one of image content, audio content, and text content;
summary circuitry to receive a set of sub-items comprising at least some of the plurality of sub-items and generate a summary content in dependence on the set of sub-items, the summary circuitry comprising one or more machine learning models trained to generate the summary content; and
storage circuitry to store the summary content.

2. The data processing apparatus according to claim 1, wherein one or more of the machine learning models are trained to generate a text-based script in dependence on the set of sub-items.

3. The data processing apparatus according to claim 2, wherein one or more of the machine learning models are trained to generate the text-based script in dependence on a target length for the text-based script.

4. The data processing apparatus according to claim 3, wherein the target length is set in dependence on feedback data associated with playback by the user of one or more previously generated instances of summary content, the feedback data indicative of a duration of a played back proportion of at least one of the one or more previously generated instances of summary content.

5. The data processing apparatus according to claim 1, wherein the set of sub-items comprises one or more non-accessed sub-items associated with a respective content item of the plurality of content items, each non-accessed sub-item having not been accessed by the user within the set time interval, and each of the one or more non-accessed sub-items associated with the respective content item being associated with a portion of the respective content item.

6. The data processing apparatus according to claim 1, wherein in a first mode of operation the set of sub-items comprises only a plurality of non-accessed sub-items associated with one or more respective content items of the plurality of content items, and in a second mode of operation the set of sub-items comprises only a plurality previously accessed sub-items associated with one or more respective content items of the plurality of content items, wherein one of the first mode of operation and the second mode of operation is selected in response to a user input by the user.

7. The data processing apparatus according to claim 1, wherein the user data is indicative of one or more previously accessed sub-items associated with a respective content item of the plurality of content items, and wherein the access circuitry is configured to obtain one or more non-accessed sub-items associated with the respective content item of the plurality of content items in dependence on the user data.

8. The data processing apparatus according to claim 7, wherein at least one of the previously accessed sub-items is associated with at least one of temporal portion and a spatial portion of a video game, and the access circuitry is configured to obtain one or more non-accessed sub-items also associated with at least one of the temporal portion and the spatial portion of the video game.

9. The data processing apparatus according to claim 1, wherein the user data is indicative of one or more non-accessed sub-items associated with a respective content item of the plurality of content items, and wherein the access circuitry is configured to obtain one or more of the non-accessed sub-items associated with the respective content item of the plurality of content items in dependence on the user data.

10. The data processing apparatus according to claim 9, wherein one or more of the non-accessed sub-items comprise at least one of image content, audio content, and text content associated with one or more:
a skipped portion of a video game;
a skipped in-game dialogue in a video game;
a skipped virtual object in a computer generated environment associated with a video game;
a future portion of a video game accessible by continued progression of the video game by the user;
a skipped portion of an audio-only content; and
a future portion of an audio-only content.

11. The data processing apparatus according to claim 1, wherein the receiving circuitry is configured to receive second user data indicative of a second plurality of content items accessed by the user within another set time interval starting at or subsequent to an end of the set time interval, and wherein:
the access circuitry is configured to obtain a second plurality of sub-items associated with one or more of the second plurality of content items from one or more content sources in dependence on the second user data, the second plurality of sub-items each comprising at least one of image content, audio content, and text content;
the summary circuitry is configured to generate a second summary content in dependence on a second set of sub-items comprising at least some of the second plurality of sub-items using one or more of the machine learning models; and
the storage circuitry is configured to store the second summary content.

12. The data processing apparatus according to claim 1, wherein the set of sub-items comprises a subset of the plurality of sub-items selected in dependence on one or more selection parameters that specify one or more user preferences.

13. The data processing apparatus according to claim 12, wherein the one or more user preferences comprise one or more:
one or more video game genres;
one or more video game titles;
one or more video game sets comprising a plurality of associated video game titles;
one or more podcast genres; and
one or more audiobook genres.

14. The data processing apparatus according to claim 12, wherein the summary circuitry is configured to define an ordered sequence for the set of sub-items in dependence on the user preferences and priority ratings associated with the user preferences, and wherein the summary circuitry is configured to generate the summary content in dependence on the ordered sequence for the set of sub-items.

15. The data processing apparatus according to claim 1, wherein the user data is indicative of a plurality of content items accessed using one or more user devices of the user within the set time interval, the one or more user devices comprising one or more of a video game console and a smartphone device.

16. The data processing apparatus according to claim 1, wherein the plurality of content items comprise at least one of one or more audio-visual content items and one or more audio-only content items.

17. The data processing apparatus according to claim 1, wherein the plurality of content items comprise one or more video games.

18. A computer implemented method comprising:
receiving user data indicative of a plurality of content items accessed by a user within a set time interval;
obtaining a plurality of sub-items associated with one or more of the plurality of content items from one or more content sources in dependence on the user data, the plurality of sub-items each comprising at least one of image content, audio content, and text content;
receiving, by summary circuitry, a set of sub-items comprising at least some of the plurality of sub-items and generating summary content in dependence on the set of sub-items, the summary circuitry comprising one or more machine learning models trained to generate the summary content; and
storing the summary content.

19. (canceled)

20. A non-transitory computer-readable storage medium storing computer software which when executed by a computer causes the computer to perform a method comprising:
receiving user data indicative of a plurality of content items accessed by a user within a set time interval;
obtaining a plurality of sub-items associated with one or more of the plurality of content items from one or more content sources in dependence on the user data, the plurality of sub-items each comprising at least one of image content, audio content, and text content;
receiving, by summary circuitry, a set of sub-items comprising at least some of the plurality of sub-items and generating summary content in dependence on the set of sub-items, the summary circuitry comprising one or more machine learning models trained to generate the summary content; and
storing the summary content.
